(19) United States
(12) Patent Application Publication
(10) Pub. No.: US 2003/0034953 A1
(43) Pub. Date: Feb. 20, 2003

(54) Information input device and method

(76) Inventor: David Yang, Moscow (RU)

Correspondence Address: Sergey Platonov, Cybiko, Inc., 7 , Semenovskaya Ploshad, Moscow, 105318, RU

(21) Appl. No.: 09/995,988

(22) Filed: Nov. 27, 2001

(30) Foreign Application Priority Data
Aug. 17, 2001 (RU) 2001123133 A

(51) Int. Cl. G09G 5/00

(52) U.S. Cl. 345/156

(57) ABSTRACT

There are two variants of a device for data input and a method for providing the same.

The first variant of a device contains an element for information choice with an appliance for its positioning and an executive element. It comprises a housing or a panel placed on it with a movable element for information choice, provided with its position control elements and an executive element with attached contacts of electrical circuit of input confirmation. The movable element for the symbol choice is provided with an appliance for searching a group of symbols, which includes the necessary symbol and an appliance for searching the symbol within the group. The movable element is realized as a button mounted in the panel window.

The appliance for search and choice of a group and the symbol contains radially directed guiding lines, for example, radial slits in the panel.

The second variant of a device for data input lies in realization of the appliance for searching a group of symbols and the necessary symbol as a button, mounted in the panel hole with a certain transversely directed backlash.

Contacts of electrical circuit of choosing a symbols group and contacts of electrical circuit of choosing a symbol within a group are mounted within the length of a button backlash and are closing at the button transversal movement.

A method for data input into an information system, comprising fulfillment of search, choice and input of the required symbol, wherein a set of all input symbols is preliminary divided into groups and then the two-step search is carried out: step 1—search of the group of symbols which includes the necessary symbol; step 2—search of the necessary symbol therein.

### TECHNCAL FIELD OF THE INVENTION

The present invention relates generally to information technologies and, particularly, to symbol data input.

### BACKGROUND OF THE INVENTION

The known prior art devices for symbol data input generally comprise a search and/or choice and input steps and contain a searching element and executive element.

A known kind of prior art devices for information input (the Patent RU # 2115157 Jul. 18, 1996) comprises a data selection element containing a set of electrical contacts one of which is movable and the others—related to input symbols are mounted on the stationary rectangular two-dimensional matrix, and the select control is realized via similar matrix of the selected symbol indicators; and the array of indication matrix is equal to the corresponding electrical contact matrix' array.

A shortcoming of the device is rather large overall dimensions.

Another known prior art device for symbol data input—keyboard—comprises a control element with the only key as multi-functional key. This key can move along the key axis, across it and in perpendicular direction to the key axis (Application RU #98110270/09, Jun. 03, 1998).

This kind of keyboard has limited ability for widening a set of input symbols.

The other known kind of prior art manipulators of “joystick” type, designed for parametrical data input, realizes non-fixed positioning and permanent position scanning of selection element.

The main shortcomings of manipulators of this kind for symbol data input are a difficulty of the required symbol selection, since the selection component position control is not supposed, and considerable device dimensions caused by ergonomic requirements.

A particular variety of multi-positional switch is well known in prior art, for information input with one-dimensional contacts matrix of a linear (rectangular matrix) and rotatory (polar matrix) type with positioning control elements of through-passing detent mechanisms type.

Shortcomings of said (mentioned) switches for symbol data input are considerable overall dimensions and a positioning difficulty at a small input symbols, set increase.

A prior art device is known for data input where tactile sensors mounted on the finger phalange are used (the U.S. Pat. No. 6,232,960, May 15, 2001).

A shortcoming of this device is a presence of special appliances, flexibly connected to the base device, which requires special preliminary arrangements before use appliance must be mounted on a finger phalange) that obviously reduces its convenience in use.

The widely used procedure of information input consists of searching the required symbol on the keyboard, controlling (for example, visually) the selected symbol and inputting it into information system.

This results in considerable overall dimensions of search and control elements design and of the device design in the whole.

This method is realized in most of data input devices (see also RU Pat. #2115157, Jul. 18 1996).

The shortcomings mentioned above strongly restrict possibility of using a known method and all known kinds of devices in portable information systems.

### SUMMARY OF THE INVENTION

The aim of the invention is to reduce a size of device, enlarge possibility of broadening a set of input symbols and make using the device in portable information systems more convenient.

This result is achieved by preliminary dividing of symbols' set into groups and by the further processing two-step search: step 1—searching a group of symbols in which the required one is included; step 2—searching the symbol within the group thereof.

The rule for dividing a set of symbols into groups may be based, for example, on alphabet order, logical rules, or ergonomics rules, engineer psychology and others.

Application of this method allows reducing overall dimensions of the data input device, to extend a set of input symbols and to raise convenience in use.

The known devices are inappropriate for realizing the proposed method of data input.

The invented device for realizing the proposed method of information input have a distinction because the mobile element for symbol selection is supplied with an special appliance for searching a group of symbols containing the required one and an another special appliance for searching a symbol within the group.

Movable element for selecting a symbol may be realized as a spring-loaded button that is mounted in the panel hole.

Movable element for selecting a symbol may be also realized in the panel hole as a button installed on elastic membrane.

An appliance for symbol group choice and a required symbol within the group comprises radially directed guiding elements, for example, radial slits in the panel.

The appliance for selecting a group of symbols and a required symbol may comprise a button placed in a central hole of the panel with a certain transverse backslash; with attached contacts of electrical circuit of symbol group choice and contacts of electrical circuit of symbol choice within the group mounted within the length of the button backlash, with the value selected to meet the condition of closing contacts at the button transversal movement. The executive element for symbol input confirmation is mounted on the lower butt-end of the button with ability to switch it on when the button is pressed.

The appliance for processing group search and choice can contain a marking performed on the panel face and through-passing detent mechanisms of movable element position control.

An electric contact in the executive element circuit of an input symbol may be mounted on a special support with a possibility to switch it on when the button is pressed.

The movable choice element can be also provided with a spring for return to the neutral position.

The movable choice element is combined with an executive element.

The shape of a housing or a panel is chosen to make possible data input using the only finger of the very hand that holds the device.

### BRIEF DESCRIPTION OF THE DRAWINGS

Preferred embodiments of the present invention will now be described with reference to the accompanied drawings wherein:

FIG. 1 shows schematic view of the device for data input (profile).

FIG. 2 shows view of the panel.

FIG. 3 shows schematic view of the device for information input containing the button with backlash (profile).

FIG. 4 shows view of the panel containing the button with backlash.

### DETAILED DESCRIPTION OF THE INVENTION

The movable element for selecting a symbol is realized as a button 1 mounted on the panel 2, supplied with the appliance for searching a group of symbols, including the required symbol, and an appliance for searching a symbol within the group. The appliance for searching a group of symbols is performed on the panel 2 as a hole 3 in the form of a central hole that corresponds to the neutral position of the button 1 and slits guiding lines directed radially. The appliance for searching a symbol is realized as a marking on the panel face 2 and control elements 5 of the button 1 position.

The button 1 is moved to the point of the required symbol and then is pressed down closing contacts 4 of electrical circuit for the necessary symbol input execution. Slit guiding lines may be supplied with through-passing detent mechanisms 5 for controlling button 1 position that corresponds to marked points of input symbols. Springs 6 return button 1 to the neutral position.

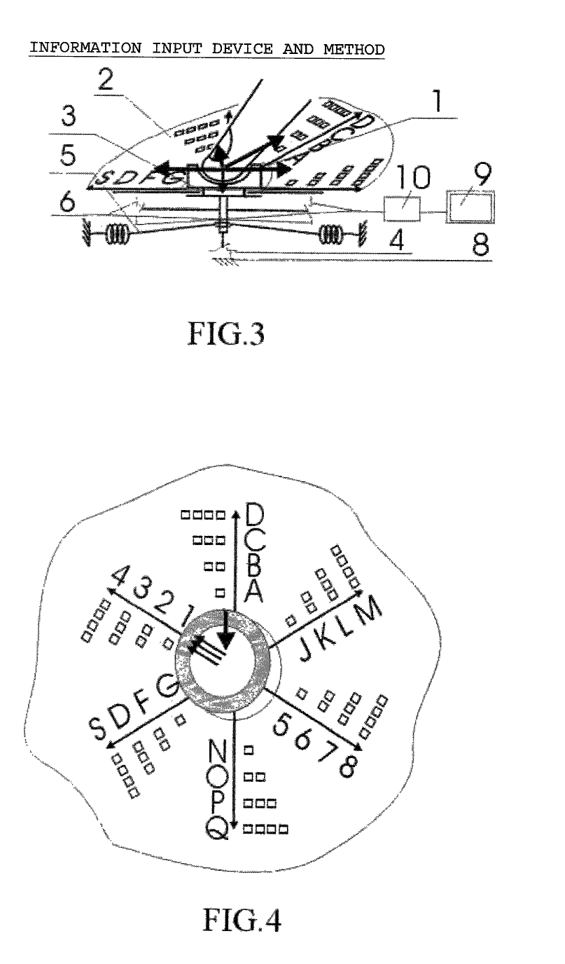

The button 1 (FIG. 3) is installed with a backlash in a hole made in the panel 2.

A special marking on the panel face 2 is made for input symbols groups together with instruction for data input.

Contacts 6 in the circuit of a group selection of symbols are mounted on periphery of the central hole of panel 2 in accordance with the marking on the panel. At the moving up to the stop position of the button 1 it effects on contacts 6 of the selected group of symbols and closes them (switches them on).

Contacts 4 for input execution (confirmation) are mounted on a special support 8 located under the lower butt-end of the button 1. A special marking on the panel face 2 is used for visual controlling a symbol group selection. For processing the data input control may be used monitor 9 of information system connected via code converter of the symbol 10. Signal to executing the symbol input consists of moving the button 1 to the neutral position and the following pressure of the button 1.

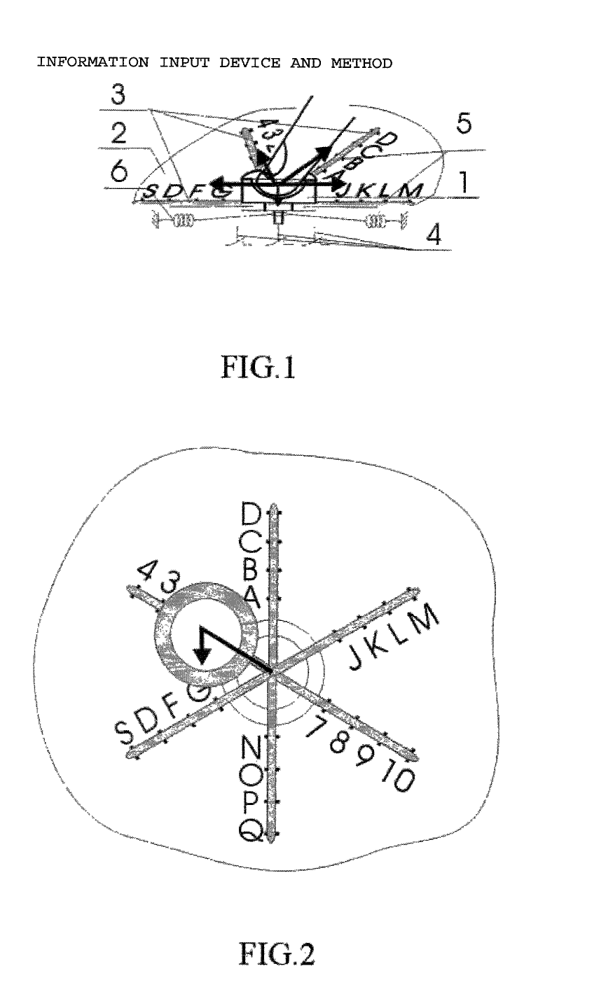

The data input order, using device with a button and radial guiding lines (FIGS. 1, 2), consists of the following operations:

Move button 1 towards the direction of the group where the required symbol is contained in to the required symbol mark:

Press button 1 to submit input;

Return button 1 to the neutral position—release it, and under the springs 5 action it will be moved to the neutral position.

Executing of input operations is controlled using marks on the panel face 2.

The data input order, using device with the button with backlash (FIGS. 3, 4), consists of the following operations:

Move button 1 towards the direction of a symbol group where the required symbol is contained in within the length of the backlash (up to the stop position) as many times as shown in the instruction (markings) on the panel face 2 for the necessary symbol;

Return button 1 to the neutral position—release it and it will move to the neutral position under the springs 5 action.

Press button 1 to submit input.

Executing input operations is controlled using marks on the panel 2 or via (by the) monitor 9 indication.

The described device allows realizing the proposed method for data input.

The proposed device concept for information input is compact and convenient in use and makes it possible to input information blindly.

I claim:

1. A device for symbol data input, comprising:
An element for data choice with an appliance for its positioning;
An executive element;
A housing or a panel, placed on the housing, with
a movable element for information choice, comprising
a movable element position control elements;
An executive element, with attached contacts of electrical circuit of data input, wherein in order to reduce size of the device and make data input more convenient the movable element for a symbol choice is provided with an appliance for searching and selecting a group of symbols containing the necessary symbol therein and an appliance for searching and selecting the symbol within the group.

2. The device of claim 1, wherein the movable element for selecting a symbol is realized as a button, mounted in the panel hole.

3. The device of claim 1, wherein the appliance for selecting a group of symbols and the necessary symbol within the group comprises radially directed guiding elements, for example, radial slits in the panel.

4. The device of claim 1, wherein the appliance for selecting a group of symbols and the necessary symbol within the group is realized as a button placed in the hole of a panel with a certain transverse backlash.

5. The device of claim 4, wherein the contacts in the electrical circuit of a group of symbols selection and the contacts in the electrical circuit of a symbol selection within the group are mounted within the length of a button backlash, which value is set to meet the condition of closing contacts at the button transversal movement.

6. The device of claims 1, 4, wherein the appliance for searching a group of symbols, which includes the necessary symbol may contain a marking performed on the panel face.

7. The device of claim 1, wherein the appliance for searching a group of symbols, which includes the necessary symbol, may contain through-passing detent mechanisms for the movable element position control.

8. The device of claim 4, wherein the contact in the circuit of an executive element of symbol input is mounted on the lower butt-end of the button with ability to close contact at the pressed button.

9. The device of claim 4, wherein the contact of a circuit of an executive element for symbol input confirmation is installed on the special support with an ability to close contact at the pressed button.

10. The device of claims 1, 4, wherein the movable choice element is provided with a spring for return to the neutral position.

11. The device of claims 1, 4, wherein the movable choice element is combined with the executive element.

12. The device of claims 4, wherein the device housing or the panel shape is chosen to make possible data input using the only finger of the very hand that holds the device.

13. The device of claim 4, wherein the button is installed on an elastic membrane.

14. A method for symbol data input into information system, comprising fulfillment of search, choice and input of the required symbol, wherein in order to reduce size of a device, enlarge abilities of widening a set of input symbols and make input process more convenient for portable information systems, a set of symbols for input is preliminary divided into groups and then the two-step search is being carried out: step 1—searching a group of symbols where the necessary symbol is included; step 2—searching the necessary symbol within the group of symbols.
